(19) United States
(12) Patent Application Publication
(10) Pub. No.: US 2025/0357834 A1
(43) Pub. Date: Nov. 20, 2025

(54) ROTOR FOR AN ELECTRIC MACHINE, ELECTRIC MACHINE, MOTOR VEHICLE AND METHOD FOR DETERMINING A ROTOR POSITION OF A ROTOR

(71) Applicant: AUDI AG, Ingolstadt (DE)

(72) Inventors: Bastian HEIDLER, Kranzberg (DE); Benjamin LEHNER, Ingolstadt (DE)

(21) Appl. No.: 19/206,795

(22) Filed: May 13, 2025

(30) Foreign Application Priority Data
May 14, 2024 (DE) 102024113367.8

(51) Int. Cl. H02K 17/16; H02K 1/16; H02K 7/00; H02K 11/26

(52) U.S. Cl. CPC H02K 17/16; H02K 1/16; H02K 7/006; H02K 11/26

(57) ABSTRACT

A rotor for an electric machine of a motor vehicle is provided, which can be used as a rotor of the electric machine, which is rotatably mounted with respect to a stator of the electric machine, wherein the rotor has a plurality of recesses distributed along a circumferential direction and extending along a longitudinal direction, wherein the geometric shapes of the cross sections of the recesses differ from one another along the circumferential direction, wherein, with respect to the assembled state of the electric machine, the recesses are each closed with respect to a radial direction towards a side of the rotor which faces the stator.

### BACKGROUND

### Technical Field

The present disclosure relates to a rotor for an electric machine of a motor vehicle, which rotor can be used as a rotor of the electric machine, which is rotatably mounted with respect to a stator of the electric machine, wherein the rotor has a plurality of recesses distributed along a circumferential direction and extending along a longitudinal direction, wherein the geometric shapes of the cross sections of the recesses differ from one another along the circumferential direction. Furthermore, the present disclosure relates to an electric machine, comprising a stator and a rotor, which is rotatably mounted with respect to the stator. Furthermore, the present disclosure relates to a motor vehicle. Finally, the present disclosure relates to a method for determining a rotor position of a rotor of an electric machine.

### Description of the Related Art

Electric machines, sometimes also referred to as electric motors, comprise a stator and a rotor. Electromagnetic interactions between field coils and, if applicable, permanent magnets of the stator or the rotor, cause the conversion of electrical energy into kinetic energy, and vice versa. Induction machines, such as externally excited asynchronous machines, in particular, do not use permanent magnets. Instead, only field coils or windings and, if applicable, squirrel cages are provided.

Controlling the operation of an electric machine typically requires knowledge of the current rotor position of the rotor, i.e., a rotational position relative to a stationary or stator-fixed reference system at that moment, which can be specified as an angle between 0° and 360° or 0 and 2π. A sensor arranged on the part of the rotor is often used for this purpose, but not without disadvantages. Such a rotor position sensor represents additional hardware, which results in additional costs and a greater overall weight of the electric machine. Furthermore, putting into operation a rotor position sensor typically requires a so-called “training” of the sensor, which means additional effort. Another disadvantage when using a rotor position sensor is that in this case, electrical signal lines are required to enable signal transmission from the rotating rotor to a stationary section of the electric machine, as a result of which interfaces susceptible to wear, such as slip rings, are required for this purpose.

Concepts for overcoming the disadvantages associated with using a rotor position sensor are known from the prior art. For example, from DE 10 2015 222 849 A1 a concept is known in which a rotor for an asynchronous machine has a plurality of slots along an outer circumference, with the opening cross sections of the slots arranged in the region of a circumferential surface of the rotor differing from one another. In this case, a rotor position sensor becomes obsolete, since these differences result in characteristic harmonics in the line current of the asynchronous machine, the evaluation of which enables the determination of the current rotor position.

Another concept, in which an asymmetry of the rotor with respect to its longitudinal or axis of rotation is specifically introduced, is known from published patent application DE 101 50 355 A1. This document discloses an electric machine drive with a rotor and a stator, wherein a plurality of active rotor slots are provided around the rotor, evenly spaced, whose depth varies in a repeating pattern. The active rotor slots thus cause the creation of a saliency, enabling sensorless control of the electric machine drive.

### BRIEF SUMMARY

Embodiments of the present disclosure provide an improved concept in connection with an electric machine in which structures are specifically introduced into the rotor to generate an asymmetry concerning the magnetic properties of the rotor, in particular with regard to improving the efficiency of the electric machine.

According to embodiments of the present disclosure, improvements may be achieved in a rotor of the type mentioned at the outset in that, with regard to the assembled state of the electric machine, the recesses are each closed with respect to a radial direction towards the side of the rotor which faces the stator.

At times, the disclosure is based on the idea of overcoming a disadvantage of the concept known from the prior art, in which corresponding recesses are provided. As such, the present disclosure provides for the at least one recess to be closed in the direction that faces the stator in the assembled state of the respective electric machine and thus, in contrast to the systems from the prior art, has no opening there that leads outside the respective recess. This advantageously ensures that no additional air turbulence occurs at the recesses during rotation of the rotor, which would be the case if corresponding openings were present. As such, an air gap is typically present between an outer surface of the rotor or a laminated core of the rotor extending along the circumferential direction and an outer surface of the stator extending along the circumferential direction and being opposite the outer surface of the rotor, wherein a recess open towards this gap would cause the air within the gap to swirl during rotation of the rotor, resulting in a braking effect with respect to the rotation of the rotor. Such a braking effect does not occur in embodiments of the present disclosure, resulting, within the scope of the present disclosure, in an improved efficiency for a corresponding electric machine. In particular, unevenness, such as corners and edges, in the area of the outer surface of the rotor, which are inevitably present in the case of correspondingly open recesses, is avoided. Therefore, within the scope of the present disclosure, this outer surface is instead in at least some embodiments advantageously flat or smooth. The outer surface of the rotor and the outer surface of the stator may be cylindrical and arranged concentrically to one another.

According to the disclosure, it is provided that the recesses are each closed with respect to the radial direction towards the side that, with regard to the assembled state of the electric machine, faces the stator. A cross-sectional area of the respective recess can be defined with respect to a sectional area perpendicular to the longitudinal direction. The geometric shape of the cross-sectional area of the respective recess has a circumferential line that is closed at least in the direction facing the stator and delimits the cross-sectional area. The circumferential line may also be closed with respect to the other directions, i.e., closed in all directions. The recesses therefore may have only two openings, namely, one opening on each of the two end faces of the rotor. Air is preferably, in particular exclusively, arranged within the recesses, so that the recesses can also be referred to as air cavities.

The recesses are configured differently from one another along the circumferential direction or have different geometric shapes or manifestations. This means that for at least some of the recesses, their cross-sectional areas vary relative to one another. With regard to the circumferential direction, it is conceivable that the corresponding cross-sectional areas vary from recess to recess. The cross-sectional areas can vary cyclically around a full perimeter in the circumferential direction, so that a deviation of the center of mass of the rotor from the longitudinal direction running centrally through the rotor due to these variations is avoided. This avoids an imbalance that would otherwise occur during rotation of the rotor. With respect to the variations, it is conceivable that a value of at least one of the dimensions and/or a value of the surface area of the cross-sectional areas varies along the circumferential direction, in particular cyclically, such as, for instance, according to a sine function.

The electric machine may be an internal rotor, in which the rotor is arranged in a region radially further inward than the stator. In this case, the recesses are closed in the radially outward direction, with regard to the assembled state of the electric machine. In principle, it is also conceivable for the electric machine to be an external rotor, in which the rotor is arranged in a region radially further outward than the stator. In this case, the recesses are closed in the radially inward direction, with regard to the assembled state of the electric machine.

Spatial directions relevant to the present disclosure are defined below. As such, the rotor, with regard to the assembled state of the electric machine, is rotatably mounted about an axis of rotation, for example by way of corresponding rotor bearings, which connect the rotor to the stator and/or a housing of the electric machine. The longitudinal direction of the rotor or of the electric machine extends along the axis of rotation. The rotor and/or the stator may be symmetrical with regard to the axis of rotation and apart from the variations in the recesses. The radial direction extends perpendicularly away from the longitudinal direction. The circumferential direction extends tangentially along the circles running concentrically with respect to the longitudinal direction, or, in other words, both perpendicularly along the longitudinal direction and along the radial direction. Each of recesses may have an elongated extent, with an axial direction extending along this extent preferably extending parallel to the longitudinal direction. The cross-sectional area of the respective recess may advantageously remain constant along the axial direction.

The rotor according to the disclosure may have a plurality of rotor teeth distributed along the circumferential direction and extending along the radial direction and along the longitudinal direction. In the case of the internal rotor, the rotor teeth extend radially outward, and in the case of the external rotor, the rotor teeth extend radially inward. An extent of the rotor teeth along the circumferential direction, i.e., a width of the respective rotor tooth, may be significantly smaller than the extents provided with respect to the radial and circumferential directions. As such, the width of the rotor tooth may correspond to less than half, particularly less than a quarter, of the radial extent or length of the respective rotor tooth.

Advantageously, a slot may be formed between each two adjacent rotor teeth, in each of which a bar of a squirrel cage is received. The squirrel cage typically comprises a plurality of bars extending along the longitudinal direction, each of which is arranged in one of the slots. The cross-sectional area of the respective bar preferably corresponds to the cross-sectional area of the slot in which this bar is arranged. As such, the bars may be received in the respective slot without play, in other words, there is no free space between the respective bar and an inner surface of the respective recess. The rotor teeth and/or the slots can have identical geometries.

It is conceivable that the bars extend beyond the front end faces of the rotor. The bars can be electrically connected to one another at their front ends via an end ring of the squirrel cage, so that the bars can also be referred to as short circuit bars. As such, an end ring may be provided on each of the two front end faces of the rotor or the rotor's laminated core. The squirrel cage, i.e., the bars and the end ring(s), comprise or consist of an electrically conductive material, such as copper.

Advantageously, each of the recesses may extend through one of the rotor teeth. In the case of an internal rotor, the recesses are provided in a radially outer section of the rotor, for example, in an outer half of the rotor with regard to the radial extent of the rotor. Consequently, the recesses cause a greater asymmetry of the magnetic properties of the rotor than in the case where the recesses were arranged radially inward. In the case of an external rotor, the recesses are provided in a radially inner section of the rotor, for example, in an inner half of the rotor with regard to the radial extent of the rotor.

Each of the recesses may extend through a tooth tip region of the respective rotor tooth. The tooth tip region is, in particular, the open or free end of the respective rotor tooth with respect to the radial direction. With regard to the internal rotor, the tooth tip region is arranged radially outwardly and, with regard to the external rotor, it is arranged radially inwardly on the respective rotor tooth. The tooth tip region can be specifically defined as a radially outer or inner half of the respective rotor tooth.

It is conceivable that exactly one of the recesses extends through each of the rotor teeth. This means that the number of rotor teeth corresponds to the number of recesses. It is also conceivable that the number of recesses extending through each rotor tooth is the same for all rotor teeth. In this case, the number of recesses corresponds to an integer multiple of the number of rotor teeth.

It may be provided that the at least one recess extending through one of the rotor teeth is arranged and formed symmetrically with respect to a central axis of the respective rotor tooth extending along the radial direction. As such, the recesses influence the local distribution and, in particular, the density of the magnetic field lines passing through the respective rotor tooth, wherein the symmetries of the recesses provided in this embodiment prevent unnecessary asymmetries in the magnetic field lines, in particular local peaks in their density.

The rotor according to the disclosure may comprise a laminated core comprising a plurality of stacked sheets, wherein openings in alignment with the longitudinal direction, in particular punch-outs, of the sheets form the recesses. The laminations may be identical to one another. The sheets may comprise or consist of iron.

Two conceivable embodiments regarding the closure of the recesses with respect to the direction facing the stator are explained below. For example, it is conceivable that at least one of the recesses, in particular all of the recesses, is arranged at a radial distance from the outer surface of the laminated core extending along the circumferential direction. In other words, in the case of the internal rotor, a maximum radial distance between the respective recess and the axis of rotation is smaller than a radial distance of the outer surface of the rotor from the axis of rotation. In the case of the external rotor, a minimum radial distance between the respective recess and the axis of rotation is correspondingly greater than the radial distance of the outer surface of the rotor from the axis of rotation. With regard to the cross-sectional area, the respective recess is therefore enclosed on all sides by the material of the laminated core.

Additionally or alternatively, it is conceivable that at least one of the recesses, in particular all of the recesses, is formed directly on the or an outer surface of the laminated core extending along the circumferential direction, wherein the laminated core is arranged, with regard to the radial direction, inside or outside a rotor sleeve which closes off the recesses towards the side of the rotor. The laminated core is arranged inside the rotor sleeve if the respective electric machine is an internal rotor. The laminated core is arranged outside the rotor sleeve if the respective electric machine is an external rotor. Within the scope of this embodiment, the corresponding recess is open towards the stator with regard only to the laminated core, wherein the closure of the respective recess provided according to the disclosure is brought about by the rotor sleeve. The rotor sleeve may comprise or consist of a magnetically non-conductive material, such as a carbon fiber reinforced and/or a glass fiber reinforced plastic.

In particular, with regard to the sectional plane perpendicular to the longitudinal direction, it is conceivable for the cross sections of the recesses to have round and/or polygonal shapes. With respect to the round shapes, circular and/or elliptical shapes are conceivable. The shapes of the cross sections of the recesses can differ in terms of their respective diameters. With regard to the polygonal shapes, rectangular or trapezoidal shapes are conceivable. The shapes of the cross sections of the recesses can differ in terms of their respective side lengths. In particular, a width of the rectangular recesses can extend along the circumferential direction and a height can extend along the radial direction. In this case, the shapes of the cross sections can differ with respect to width and/or height.

The present disclosure further relates to an electric machine comprising a stator and a rotor rotatably mounted with respect to the stator. According to the disclosure, improvements may be achieved in such an electric machine in that the rotor is a rotor as described above. The electric machine can be an internal rotor or an external rotor. The electric machine can be an asynchronous machine, wherein all aspects explained at the outset with regard to asynchronous machines are applicable to the electric machine according to the disclosure. All advantages, features, and aspects explained in connection with the rotor according to the disclosure are equally applicable to the electric machine according to the disclosure, and vice versa.

The stator may have a plurality of stator teeth distributed along the circumferential direction and extending along the radial direction and along the longitudinal direction, wherein between two adjacent stator teeth in each case a stator slot is formed in which stator windings are received. The aspects explained in connection with the rotor teeth, insofar as technically expedient, are equally applicable to the stator teeth. The stator windings may be carried by the stator teeth. This means that at least one conductor wire forming the stator windings is wound around at least one of the stator teeth. The stator windings implement electromagnetic field coils which, when electrically energized, cause the formation of an alternating electromagnetic field present on the part of the stator, which in turn interacts with the rotor, in particular with the squirrel cage of the rotor, to generate the drive or traction torque that can be generated by the electric machine. The stator windings can be distributed or concentrated windings.

Advantageously, the electric machine may be connectable to a drive train of a motor vehicle, wherein, with regard to the state connected to the drive train, a traction torque can be generated by way of the electric machine and transmitted to the wheels of the motor vehicle via the drive train. For example, an open end of a rotor shaft of the rotor extending along the axis of rotation can be provided, in particular protruding from a housing of the electric machine. This end and a component of the drive train can each have a connecting means or device, such as a connecting flange, by way of which a mechanical connection, in particular a rotationally fixed one, can be established between the shaft and the drive train. The drive train is generally understood to mean all components via which a mechanical coupling can be established between the electric machine and the wheels. The drive train can therefore comprise drive shafts and/or transmissions, in particular manual and/or differential gears and/or clutches.

The present disclosure further relates to a motor vehicle. Improvements may be further achieved according to the disclosure in that the motor vehicle comprises a traction motor designed as an electric machine according to the preceding section of the description. According to the disclosure, the electric machine is connected to the drive train of the motor vehicle, wherein a traction torque can be generated by way of the electric machine and transmitted to wheels of the motor vehicle via the drive train. The motor vehicle according to the disclosure can therefore be an electric or a hybrid vehicle. All advantages, features, and aspects explained in connection with the rotor according to the disclosure and the electric machine according to the disclosure are equally applicable to the motor vehicle according to the disclosure, and vice versa.

Finally, the present disclosure relates to a method for determining a rotor position of a rotor of an electric machine according to the above section of the description. According to the disclosure, improvements may be achieved in that the method comprises the following steps:
producing of an alternating voltage present on the part of the stator,
generating an alternating electromagnetic field present on the part of the stator by way of the alternating voltage present on the part of the stator,
inducing an alternating voltage present on the part of the rotor by way of the alternating field present on the part of the stator,
generating an alternating electromagnetic field present on the part of the rotor by way of the alternating voltage present on the part of the rotor, wherein this alternating field depends on the current position of rotation of the rotor due to the differences in the geometric shapes of the cross sections of the recesses along the circumferential direction,
inducing a feedback voltage present on the part of the stator by way of the alternating electromagnetic field present on the part of the rotor, and
determining the current position of rotation of the rotor on the basis of the feedback voltage.

All advantages, features and aspects explained in connection with the rotor according to the disclosure, the electric machine according to the disclosure and/or the motor vehicle according to the disclosure are equally applicable to the method according to the disclosure, and vice versa.

In the method according to the disclosure, a reaction occurring on the part of the rotor is caused by electromagnetic induction due to the alternating voltage present on the part of the stator or the alternating field present on the part of the stator, wherein this reaction in turn depends on the current rotor position. This reaction consists in the induction of a corresponding alternating voltage on the part of the rotor. This alternating voltage in turn causes a reaction to take place on the part of the stator, namely, the generation of the corresponding feedback voltage present on the part of the stator. Since the alternating voltage generated on the part of the rotor depends on the current rotor position, the feedback voltage induced in response to this also depends on the current rotor position. This allows information regarding the current rotor position to be obtained on the basis of the feedback voltage. Instead of using a position sensor present on the part of the rotor, which would be associated with the disadvantages described above, in the present case, the detection of the current rotor position, knowledge of which is necessary for the control of the electric machine, is carried out exclusively wirelessly and by way of electromagnetic interactions or inductions between the stator and the rotor, and vice versa. Roughly summarized, the approach according to the disclosure implements an evaluation of a double-linked voltage.

Advantageously, an electrical energy store of the motor vehicle and stator windings of the stator may be connected to one another via a power electronics device. The electrical energy store of the motor vehicle, which can also be referred to as an accumulator, serves to store electrical energy, which is converted into kinetic energy by way of the electric machine during driving of the motor vehicle. The electrical energy store can be a lithium-ion accumulator. The power electronics device therefore implements at least a rectifier or an inverter. By way of the power electronics device, a direct voltage provided on the part of the energy store is converted into the alternating voltage present on the part of the stator, which is then supplied to the stator windings, so that the alternating electromagnetic field present on the part of the stator is generated by way of the alternating voltage present on the part of the stator.

It is conceivable that a modulating signal having a higher frequency with respect to the alternating voltage present on the part of the stator is modulated at least temporarily, i.e., for a certain period of time, onto this alternating voltage, wherein the current position of rotation of the rotor is determined on the basis of the portion of the feedback voltage resulting from the modulating signal. The alternating voltage present on the part of the stator can be at least substantially sinusoidal. The higher-frequency modulating signal can also be sinusoidal, wherein a period of the modulating signal can be shorter than a period of the alternating voltage and an amplitude of the modulating signal can be smaller than an amplitude of the alternating voltage. The modulating signal can be referred to as or understood to be a harmonic of the alternating voltage present on the part of the stator. The alternating voltage present on the part of the stator is used in the present case in the course of generating the drive or traction torque. The modulating signal is sufficiently weak compared to the alternating voltage so that changes in the traction torque occurring due to the modulating signal are negligible. Nevertheless, the feedback caused by the modulating signal and occurring in the context of the double-linked voltage can be used to determine the current rotor position.

To carry out the method according to the disclosure, a control device configured for this purpose can be provided. The control device can be a component of the electric machine or of the motor vehicle. The control device can be configured to control the operation of the electric machine in the context of generating the traction torque. The control device is thus configured to generate control signals provided in this context and output them to the respective components. In particular, the operation of the power electronics device and thus the production of the alternating voltage present on the part of the stator can be controlled by way of the control device. Specifically, the control device can bring about the generation the control signals on the basis of a specification signal, for example, specified on the part of the driver or on the part of an at least partially autonomous vehicle control system, in such a way that the control signals cause the generation of a correspondingly specified traction or braking torque by way of the electric machine. Furthermore, the generation of the modulating signal can be controllable by way of the control signals. In addition or alternatively, an evaluation of the feedback voltage can be carried out by way of software implemented on the part of the control device in order to determine information concerning the current rotor position.

### BRIEF DESCRIPTION OF THE SEVERAL VIEWS OF THE DRAWINGS

Further advantages, features, and details of the present disclosure will become apparent from the following example embodiments and from the figures.

FIG. 1 shows a schematic diagram of a motor vehicle according to an example embodiment, comprising an electric machine according to an example embodiment, wherein a method according to an example embodiment is explained on the basis of this motor vehicle.

FIG. 2 shows a cross-sectional representation of a sector of the electric machine of the motor vehicle of FIG. 1, comprising a rotor according to and example embodiment and a stator.

FIG. 3 shows a cross-sectional representation of a sector of a rotor according to a further example embodiment.

### DETAILED DESCRIPTION

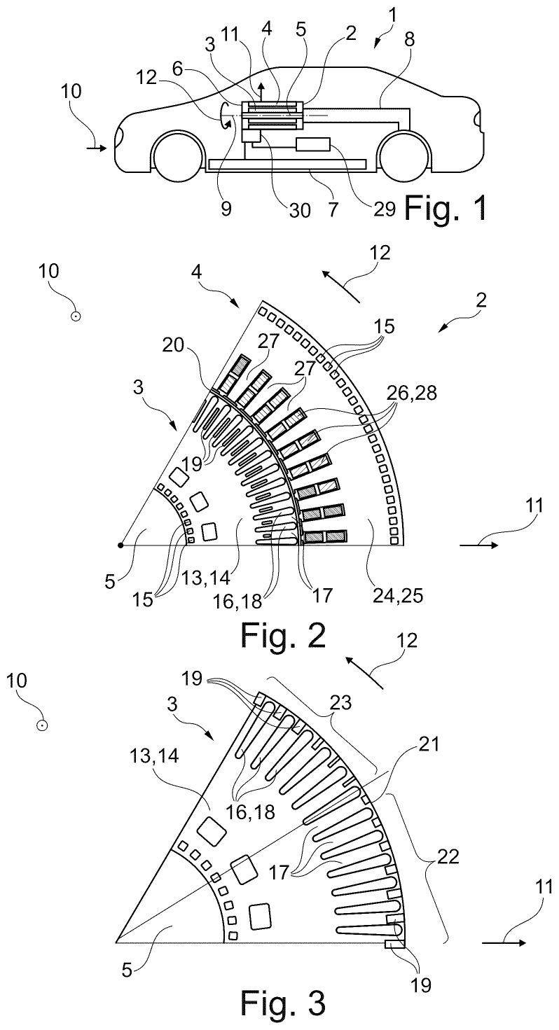

FIG. 1 shows a motor vehicle 1 according to an example embodiment, comprising an electric machine 2 according to an example embodiment. Electric machine 2 comprises a rotor, which is a rotor 3 according to an example embodiment, and a stator 4. Electric machine 2 is an internal rotor. This means that rotor 3 is arranged in a region of electric machine 2 that is radially further inward than a region in which stator 4 is arranged. A rotor shaft 5 of rotor 3 is rotatably mounted on a housing 6 of the electric machine 2, for example by way of a ball or roller bearing. In principle, it is also conceivable within the scope of the present disclosure for electric machine 2 to be an external rotor, in which case the positions of rotor 3 and stator 4 are interchanged.

Electric machine 2, designed as an asynchronous machine, is configured to convert electrical energy stored in an electrical energy store 7 of motor vehicle 1 into kinetic energy of motor vehicle 1, and vice versa. A generated drive or traction torque, which can be used to propel motor vehicle 1, can be transmitted from electric machine 2 to a drive train 8 of motor vehicle 1. For this purpose, rotor shaft 5 has a corresponding connecting means or device, such as a connecting flange or the like. In the example embodiment shown, the drive torque can be transmitted only to the rear wheels, for example, but can additionally or alternatively also be transmitted to the front wheels.

Below, definitions regarding relevant spatial directions are introduced with reference to electric machine 2. As such, rotor shaft 5, and thus rotor 3, are rotatably mounted about an axis of rotation 9, which extends along a longitudinal direction 10 of electric machine 2. A radial direction 11 extends perpendicular to longitudinal direction 10. A circumferential direction 12 is perpendicular to radial direction 11. This means that a point rotating about axis of rotation 9 moves along circumferential direction 12.

Details regarding rotor 3 and stator 4 are explained below with reference to FIG. 2. FIG. 2 shows a cross-sectional representation of a sector of electric machine 2, wherein the sectional plane is perpendicular to longitudinal direction 10. Rotor 3 comprises a laminated core 13 formed from a plurality of sheets 14 comprising or consisting of iron, which are stacked along longitudinal direction 10. As can be seen, sheets 14 comprise a plurality of recesses or punch-outs aligned along longitudinal direction 10. Some of the punch-outs form cooling channels 15 for guiding a cooling fluid.

In addition, some of the punch-outs form slots 16 of rotor 3, which, with regard to radial direction 11, are laterally delimited by rotor teeth 17 evenly distributed along circumferential direction 12. Bars 18 of a squirrel cage are received within slots 16. Slots 16, rotor teeth 17, and bars 18 extend primarily along longitudinal direction 10 and radial direction 11. The cross-sectional area of bars 18 corresponds to the cross-sectional area of respective slot 16, so that bars 18 are received in respective slot 16 without any play. Although this is not apparent from the figures, bars 18 protrude slightly beyond end faces of laminated core 13 and are electrically contacted with one another at their end faces by way of an end ring of the squirrel cage. Bars 18 and the end rings comprise or consist of copper.

Finally, some of the punch-outs form recesses 19 that are filled with air and can therefore also be referred to as air cavities. The geometric shapes of the cross sections of recesses 19 differ from one another along circumferential direction 12. The purpose of this will be explained later in connection with the explanation of the method according to the disclosure.

With regard to recesses 19, it is provided that they are closed with respect to radial direction 11 on the side facing stator 4. Furthermore, in the exemplary embodiment shown here, recesses 19 are closed on all sides when viewed in cross section. Recesses 19 have openings only at the front ends of laminated core 13. Recesses 19 are each arranged at a radial distance from an outer surface of laminated core 13 extending along circumferential direction 12. This outer surface delimits a hollow cylindrical air gap 20, which has a width of a few millimeters and is arranged between rotor 3 and stator 4. It is clear that air present in air gap 20 would be swirled during the rotation of rotor 3 if recesses 19 were open with respect to the radial direction facing stator 4 and thus air gap 20. The aspect that recesses 19 are closed towards air gap 20 prevents an otherwise occurring inhibition of the rotation of rotor 3 and thus improves the efficiency of electric machine 2.

With respect to the specific geometric configuration of recesses 19, it is provided that their cross section remains constant along longitudinal direction 10. In addition, recesses 19 extend in each case through one of stator teeth 17, wherein each of stator teeth 17 has a same number of recesses 19, in particular, as in the present case, exactly one. To avoid asymmetries of the magnetic flux within stator teeth 17, each of recesses 19 is formed symmetrically with respect to a central axis of the respective rotor tooth 17 running along radial direction 11. If, within the scope of a specific embodiment of the disclosure, several recesses 19 were provided for each of stator teeth 17, these may also be arranged symmetrically about the central axis of respective rotor tooth 17.

With respect to the cross-sectional geometry of recesses 19, it is provided that the cross sections of recesses 19 have polygonal, namely, rectangular, shapes. However, this is only an example configuration; additionally or alternatively, round, in particular elliptical or circular, cross-sectional geometries are also conceivable. Also by way of example, the variation in geometry of the cross sections of recesses 19 along circumferential direction 12 is implemented by the rectangles, each of which has the same width, varying their height. As such, the height of these rectangles varies cyclically along circumferential direction 12 from a maximum height to a minimum height, back to the maximum height, and so on.

Before details with respect to stator 4 are explained below with reference to FIG. 2, another conceivable embodiment of rotor 3 according to the disclosure will first be explained with reference to FIG. 3. This figure shows a cross-sectional representation corresponding to FIG. 2, showing only rotor 3. As such, all aspects explained in connection with electric machine 2 in FIG. 2 apply equally to the example embodiment shown in FIG. 3, unless explicitly stated otherwise. Rotor 3 in FIG. 3 differs from rotor 3 in FIG. 2 in that recesses 19 to stator 4 or air gap 20 are not closed off by the material of laminated core 13. Instead, recesses 19 are formed directly on the outer surface of laminated core 13 extending along circumferential direction 12. To prevent the recesses from being open towards air gap 20, laminated core 13 is arranged, with regard to radial direction 11, within a rotor sleeve 21, which closes off recesses 19 towards air gap 20. In the case of electric machine 2 designed as the external rotor, within the scope of this embodiment, laminated core 13 would be arranged radially outside rotor sleeve 21.

Another difference between the example embodiments explained with reference to FIGS. 2 and 3 is that, in each case, recesses 19 in FIG. 3 extend through a tooth tip region of respective rotor tooth 17. The tooth tip region is understood to mean the radially outer or the open end of respective rotor tooth 17.

Similarly to FIG. 2, the recesses in the exemplary embodiment shown in FIG. 3 are rectangular in cross section, with FIG. 3 showing two areas 22, 23 in this regard, each showing conceivable variations within the scope of the disclosure with respect to the variation in the cross-sectional area of recesses 19 along circumferential direction 12. While in area 22 the variation in the cross-sectional area is implemented, similarly to the embodiment shown in FIG. 2, by varying the height of the respective rectangle while maintaining the same width, region 23 shows the other case in this respect, in which the width of the rectangle varies while maintaining the same height. Although these cases are provided for one and the same rotor 3 in the example embodiment shown in FIG. 3, respective rotor 3 is preferably limited to only one of these alternatives instead.

Details with respect to stator 4 are explained below with further reference to FIG. 2. Stator 4 also comprises a laminated core 24 formed from a plurality of sheets 25 comprising or consisting of iron, wherein punch-outs aligned along longitudinal direction 10 form stator slots 26. Stator slots 26 are delimited laterally by stator teeth 27 with regard to radial direction 11. Stator windings 28 formed from conductor wires comprising or consisting of copper are provided within stator slots 26.

A method according to the disclosure is explained below according to an example embodiment on the basis of motor vehicle 1 shown in FIG. 1 and electric machine 2 shown in FIG. 2, wherein the points explained in connection with the method are equally applicable to the example embodiment shown in FIG. 3. The control commands required to carry out the method are generated on the part of a control device 29 of motor vehicle 1, which can also be a component of electric machine 2. Control device 29 is further configured to carry out the evaluation steps required in the course of carrying out the method.

First, an alternating voltage present on the part of stator 4 or stator windings 28 is generated. For this purpose, electrical energy store 7 and stator windings 28 are connected via a power electronics device 30, which is configured to convert a direct voltage present on the part of energy store 7 into an alternating voltage required on the part of electric machine 2, and vice versa. For this purpose, power electronics device 30 can be brought into corresponding circuit states by way of the control commands generated by control device 29. In summary, an electrical direct voltage is provided on the part of energy store 7, which is converted into an alternating voltage by way of power electronics device 30 and depending on control commands generated by control device 29, wherein this alternating voltage, which has at least an approximately sinusoidal shape, is supplied to stator windings 28.

The production of the alternating voltage present on the part of stator 4 is carried out during the generation of a traction torque carried out by way of electric machine 2. As such, control device 29 is configured to bring about the generation of the control signals on the basis of a specification signal, for example, specified on the part of the driver or on the part of an at least partially autonomous vehicle control system, in such a way that the power electronics device 30 is placed into a circuit state in which the alternating voltage is supplied to stator windings 28 in such a way that a correspondingly specified traction or braking torque is caused by way of the electric machine. The alternating voltage present on the part of stator 4, or the electric current formed in stator windings 28 due to this alternating voltage, causes the creation of an alternating electromagnetic field, which in turn interacts electromagnetically with rotor 3 or the squirrel cage to generate the drive torque.

The control commands generated by control device 29 further cause a modulating signal to be modulated, at least temporarily, onto the alternating voltage present on stator 4 or onto the sinusoidal base signal of this alternating voltage. A frequency of the modulating signal is higher than a frequency of the alternating voltage. The modulating signal, like the alternating voltage present on the part of stator 4, can have a sinusoidal shape. The amplitude of the modulating signal is preferably smaller than the amplitude of the alternating voltage, so that the modulating signal is sufficiently weak or small compared to the base signal of the alternating voltage, so that any resulting influence on the traction torque is negligible.

The alternating field generated on the part of stator 4 causes, due to electromagnetic induction, the occurrence of an alternating voltage present on the part of rotor 3 or the squirrel cage, which in turn causes a corresponding alternating current and ultimately an alternating electromagnetic field present on the part of rotor 3. Since the above-described differences in the shapes of the cross sections of recesses 19 result in an anisotropy of the magnetic properties of laminated core 13 of rotor 3, the alternating voltage induced on the part of rotor 3 and thus the corresponding alternating field generated on the part of rotor 3 depend on the current rotational position of rotor 3.

The alternating electromagnetic field present on the part of rotor 3 in turn induces a feedback voltage present on the part of stator 4. Since the alternating electromagnetic field present on the part of rotor 3 depends on the current rotational position of rotor 3, this feedback voltage equally depends on this rotational position. Specifically, the portion of the feedback voltage present due to the modulating signal or corresponding to the modulating signal depends on the rotational position of rotor 3, so that this rotational position can be determined by way of the feedback voltage. Finally, an evaluation of the feedback voltage is carried out using software implemented on the part of control device 29. As a result, by way of control device 29 and on the basis of the feedback voltage, information relating to the current rotational position of rotor 3 or the rotor is determined, which in turn is further used to control the operation of electric machine 2.

German patent application no. 102024113367.8, filed May 14, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A rotor for an electric machine of a motor vehicle, which rotor can be used as a rotor of the electric machine, which is rotatably mounted with respect to a stator of the electric machine, wherein the rotor has a plurality of recesses distributed along a circumferential direction and extending along a longitudinal direction, wherein geometric shapes of cross sections of the recesses differ from one another along the circumferential direction, and wherein, with regard to an assembled state of the electric machine, the recesses are each closed with respect to a radial direction towards a side of the rotor which faces the stator.

2. The rotor according to claim 1, comprising a plurality of rotor teeth distributed along the circumferential direction and extending along the radial direction and along the longitudinal direction, wherein a slot is formed between each two adjacent rotor teeth, in each of which a bar of a squirrel cage is received.

3. The rotor according to claim 2, wherein the recesses in each case extend through one of the rotor teeth.

4. The rotor according to claim 3, wherein the recesses in each case extend through a tooth tip region of the respective rotor tooth.

5. The rotor according to claim 3, wherein exactly one of the recesses extends through each of the rotor teeth, or that a number of recesses extending through the respective rotor tooth is the same for the rotor teeth.

6. The rotor according to claim 3, wherein the at least one recess extending through one of the rotor teeth is arranged and formed symmetrically with respect to a central axis of the respective rotor tooth extending along the radial direction.

7. The rotor according to claim 1, comprising a laminated core comprising a plurality of stacked sheets, wherein openings in alignment with the longitudinal direction of the sheets form the recesses.

8. The rotor according to claim 7, wherein at least one of the recesses is arranged radially spaced from an outer surface of the laminated core extending along the circumferential direction.

9. The rotor according to claim 7, wherein at least one of the recesses is formed directly on an outer surface of the laminated core extending along the circumferential direction, wherein the laminated core is arranged, with regard to the radial direction, inside or outside a rotor sleeve which closes off the recesses towards the side of the rotor.

10. The rotor according to claim 1, wherein the cross sections of the recesses have round and/or polygonal shapes.

11. An electric machine comprising the rotor of claim 1 and the stator, wherein the rotor is rotatably mounted with respect to the stator.

12. An electric machine according to claim 11, wherein the stator has a plurality of stator teeth distributed along the circumferential direction and extending along the radial direction and along the longitudinal direction, wherein between two adjacent stator teeth in each case a stator slot is formed in which stator windings are received.

13. A motor vehicle, comprising a traction motor designed as an electric machine according to claim 11, wherein the electric machine is connected to a drive train of the motor vehicle, wherein a traction torque can be generated by the electric machine and transmitted to wheels of the motor vehicle via the drive train.

14. A method for determining a rotor position of a rotor of an electric machine which is rotatably mounted with respect to a stator of the electric machine, the rotor having a plurality of recesses distributed along a circumferential direction and extending along a longitudinal direction, wherein geometric shapes of cross sections of the recesses differ from one another along the circumferential direction, and wherein, with regard to an assembled state of the electric machine, the recesses are each closed with respect to a radial direction towards a side of the rotor which faces the stator, the method comprising:
producing an alternating voltage present on the part of the stator;
generating an alternating electromagnetic field present on the part of the stator by way of the alternating voltage present on the part of the stator;
inducing an alternating voltage present on the part of the rotor by way of the alternating field present on the part of the stator;
generating an alternating electromagnetic field present on the part of the rotor by way of the alternating voltage present on the part of the rotor, wherein this alternating field depends on a current position of rotation of the rotor due to the differences in the geometric shapes of the cross sections of the recesses along the circumferential direction;
inducing a feedback voltage present on the part of the stator by way of the alternating electromagnetic field present on the part of the rotor; and
determining the current position of rotation of the rotor on the basis of the feedback voltage.

15. The method according to claim 14, wherein an electrical energy store of the motor vehicle and stator windings of the stator are connected to one another via a power electronics device, wherein by way of the power electronics device a direct voltage provided on the part of the energy store is converted into the alternating voltage present on the part of the stator, which is then supplied to the stator windings, so that the alternating electromagnetic field present on the part of the stator is generated by way of the alternating voltage present on the part of the stator.

16. The method according to claim 14, wherein a modulating signal having a higher frequency with respect to the alternating voltage present on the part of the stator is modulated at least temporarily onto this alternating voltage, wherein the current position of rotation of the rotor is determined on the basis of the portion of the feedback voltage resulting from the modulating signal.
